(19) United States
(12) Patent Application Publication
(10) Pub. No.: US 2020/0122038 A1
(43) Pub. Date: Apr. 23, 2020

(54) METHOD AND SYSTEM FOR BEHAVIOR GENERATION WITH A TRAIT BASED PLANNING DOMAIN LANGUAGE

(71) Applicant: Unity IPR ApS, Copenhagen K (DK)

(72) Inventors: Amir Pascal Ebrahimi, Sausalito, CA (US); Nicolas Francois Xavier Meuleau, San Francisco, CA (US); Trevor Joseph Santarra, South San Francisco, CA (US)

(21) Appl. No.: 16/657,874

(22) Filed: Oct. 18, 2019

Related U.S. Application Data
(60) Provisional application No. 62/747,484, filed on Oct. 18, 2018.

(51) Int. Cl. A63F 13/57; G06N 20/00

(52) U.S. Cl. CPC A63F 13/57; A63F 2300/6027; A63F 2300/5533; G06N 20/00

(57) ABSTRACT

A method for generating behavior with a trait-based planning domain language is disclosed. A world model of a dynamic environment is created. The world model includes data defining a state for the world model. The data defining the state includes data describing objects within the environment. Input to update the state for the world model is received. The input includes data to change the state and data defining a goal for a future state. A machine-learning model is used to generate a planning state from the state for the world model. The planning state includes a plurality of planning domain objects and associated traits. Based on instructions associated with an action, one or more of modifying values within a trait associated with the planning domain object, adding a trait to the planning domain object, or removing a trait from the planning domain object are performed.

### CROSS-REFERENCE TO RELATED APPLICATIONS

This application claims the benefit of U.S. Provisional Application No. 62/747,484, filed Oct. 18, 2018, which is incorporated by reference herein in its entirety.

### TECHNICAL FIELD

The present invention relates to the field of artificial intelligence and, in one specific example, to tools for generating behaviors in a video game environment or simulation environment.

### BACKGROUND OF THE INVENTION

In the world of video games, interactive simulations, and robotics, Artificial Intelligence (AI) is used to generate various behaviors (e.g., for characters and robots).

Some current approaches to behavior and story generation use the paradigm of “reactive AI” wherein behaviors are hand-written (e.g., by a developer using) some form a behavior representation language such as finite state machines, behavior trees, and rule-based systems. In reactive AI, a behavior representation language is used to explicitly define what an agent should do in each situation. Similarly for storytelling, stories are handled through a complex puzzle dependency graph (or quest graph) which is created manually. Creating AI in this way is known to be tedious and costly, and resulting systems are very hard to read, debug, and upgrade.

Sophisticated planning domain languages use the notion of planning domain objects to represent the different entities that are part of a domain description. For example, an enemy, a location, or a manipulatable object can be represented by different planning domain objects. Usually planning domain objects have a fixed type (or class) that determines the properties and semantics attached to the object, so in the example “enemy”, “location” and “inanimate-object” can be used as types for the planning domain objects. Types are used by planning domain actions to constrain objects that can be the subject or the object of an action. A type enables actions by or with the objects that carry the type. For example, consider an action called “Attack” that takes one parameter representing the target of the attack, whereby the parameter must be a planning domain object of type “enemy”. Using types is a rigid structure that does not allow an object to acquire or lose properties at runtime (e.g., during game play) since the type of an object is determined in advance and cannot be changed at runtime during game play. Furthermore, the type of an object is most often unique, which can lead to the duplication of some planning domain actions. For example, if a character can attack both an enemy character and an inanimate object (e.g., to destroy it) then two “attack” actions would need to be defined; a first action accepting a target parameter of type “enemy” and second action with a target parameter of type “inanimate-object”. To avoid the duplication, complex languages allow type inheritance, wherein a type can inherit all the properties of another type. However, type inheritance usually comes with several problems of aliasing, and it requires that the types are defined carefully and in advance of game play. With type inheritance, a video game developer would need to oversee all combinations of properties that might be desired at runtime, and arrange a type hierarchy that accounts for all of them. Although computer scientists are familiar with this kind of reasoning, it is more difficult for a non-expert and requires much work in advance.

### BRIEF DESCRIPTION OF THE DRAWINGS

Further features and advantages of the present invention will become apparent from the following detailed description, taken in combination with the appended drawings, in which:

FIG. 1 is a schematic illustrating a behavior generation system, in accordance with one embodiment;

FIG. 2 is a schematic illustrating a method for behavior generation using a trait based planning domain language, in accordance with one embodiment;

FIG. 3 is a schematic illustrating a method for a control module to apply an action in a behavior generation system, in accordance with one embodiment;

FIG. 4 is a block diagram illustrating an example software architecture, which may be used in conjunction with various hardware architectures described herein; and

FIG. 5 is a block diagram illustrating components of a machine, according to some example embodiments, configured to read instructions from a machine-readable medium (e.g., a machine-readable storage medium) and perform any one or more of the methodologies discussed herein.

It will be noted that throughout the appended drawings, like features are identified by like reference numerals.

### DETAILED DESCRIPTION

The description that follows describes systems, methods, techniques, instruction sequences, and computing machine program products that constitute illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details.

A method for generating behavior with a trait-based planning domain language is disclosed. A world model of a dynamic environment is created. The world model includes data defining a state for the world model. The data defining the state includes data describing objects within the environment. Input to update the state for the world model is received. The input includes data to change the state and data defining a goal for a future state. A machine-learning model is used to generate a planning state from the state for the world model. The planning state includes a plurality of planning domain objects and associated traits. The planning domain objects represent objects within the state for the world model. A machine-learning planning module is used to create a plan. The plan includes a plurality of actions to be performed on planning domain objects within the planning state in order to change the state of the world model to a second state. The second state is consistent with the goal. Each action of the plurality of actions includes one or more parameters, one or more preconditions, and one or more effects. Each parameter of the one or more parameters includes one or more planning domain objects and associated traits. The plurality of actions is performed within the plan. The performing of the plurality of actions includes performing a set of operations for each action of the plurality of actions. The set of operations for each of the plurality of actions includes determining, for each parameter of the action, whether a planning domain object associated with the parameter has one or more traits that have been predefined as necessary for the execution of the action, analyzing one or more preconditions associated with one or more parameters of the action, and, based on the preconditions being satisfied, applying the action to a planning domain object associated with the parameter. The applying of the action includes, based on instructions associated with the action, performing one or more of modifying values within a trait associated with the planning domain object, adding a trait to the planning domain object, or removing a trait from the planning domain object.

The present disclosure includes apparatuses which perform the methods or one or more operations or one or more combinations of operations described herein, including data processing systems which perform these methods and computer readable media which when executed on data processing systems cause the systems to perform these methods, the operations or combinations of operations including non-routine and unconventional operations. Furthermore, many of the methods of the present disclosure may be performed with a digital processing system, such as a conventional, general purpose computer system. Special purpose computers which are designed or programmed to perform only one function may also be used.

The term ‘game’ used herein should be understood to include video games and applications that execute and present video games on a device, and applications that execute and present simulations on a device. The term ‘game’ should also be understood to include programming code (either source code or executable binary code) which is used to create and execute the game on a device.

The term ‘runtime’ used herein should be understood to include a time during which a program (e.g., an application, a video game, a simulation, and the like) is running, or executing (e.g., executing programming code). The term should be understood to include a time during which a video game is being played by a human user or an artificial intelligence agent.

The term ‘environment’ used throughout the description herein should be understood to include 2D digital environments (e.g., 2D video game environments, 2D simulation environments, and the like), 3D digital environments (e.g., 3D game environments, 3D simulation environments, 3D content creation environment, virtual reality environments, and the like), and augmented reality environments that include both a digital (e.g., virtual) component and a real-world component.

The term ‘game object’, used herein is understood to include any digital object or digital element within an environment. A game object can represent almost anything within the environment; including characters, weapons, scene elements (e.g., buildings, trees, cars, treasures, and the like), backgrounds (e.g., terrain, sky, and the like), lights, cameras, effects (e.g., sound and visual), animation, and more. A game object is associated with data that defines properties and behavior for the object.

The terms ‘asset’, ‘game asset’, and ‘digital asset’, used herein are understood to include any data that can be used to describe a game object or can be used to describe an aspect of a game or project. For example, an asset can include data for an image, a 3D model (textures, rigging, and the like), a group of 3D models (e.g., an entire scene), an audio sound, a video, animation, a 3D mesh and the like. The data describing an asset may be stored within a file, or may be contained within a collection of files, or may be compressed and stored in one file (e.g., a compressed file), or may be stored within a memory. The data describing an asset can be used to instantiate one or more game objects within a game at runtime.

Throughout the description herein, the term “agent” should be understood to include entities such as a non-player character (NPC), a robot, and a game world. Throughout the description herein, the term “AI agent” should be understood to include an agent which is controlled by an artificial intelligence system or model.

In accordance with an embodiment, there is provided a system and method for generating behavior using a trait based planning domain language. The trait based planning domain language described herein provides flexibility, and a natural and compact description of a planning domain. The behavior generator with a trait based planning domain language is easy to use for non-expert artificial intelligence (AI) programmers since the planning domain language is close to natural language and compact. The system is part of a paradigm called “deliberative AI” where an agent under control (e.g., robot, NPC or game world), is provided with a model of rationality and a problem solver to determine appropriate behavior for the agent in each encountered situation.

The purpose of generating the behaviors may be to achieve goals (e.g., goals for the characters and robots). In general, there are two levels, or scales, over which the behaviors are generated; a first level works at the individual character scale, while a second works at the scale of an entire game world (e.g., as in story generation). An example of the first level involves behaviors for non-player characters (NPCs) in video games and can also include behaviors for robots in robotics. At this first level, a typical goal would be to generate high-level agent behavior, which might include a list of activities to perform over time, a series of places to travel to, and generally governing what the agent does at the highest level of abstraction (as opposed to low level behaviors such as character navigation and animation). An example of the second level involves generating behaviors that drive narration of a story through certain points. The goal for storytelling in games and simulations is to generate, enable and disable events, quests and other opportunities for a player to act on.

In a paradigm called “deliberative AI”, instead of providing explicit behaviors to the agent under control (e.g., robot, NPC or game world), a model of rationality is provided to the agent and a problem solver determines the appropriate behavior in each encountered situation. The model of rationality requires a planning domain description language to describe the model of rationality to the AI. Existing systems (e.g., developed mostly for robotics purpose) use languages that are based on rigid types (and classes) and flat predicates.

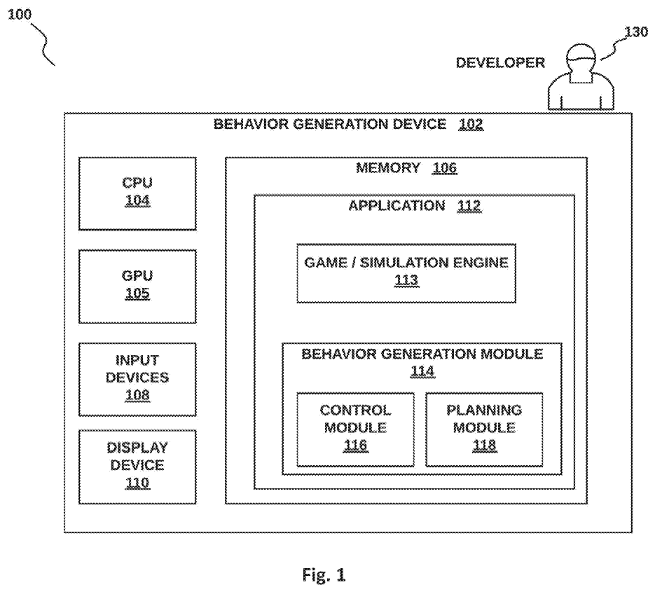

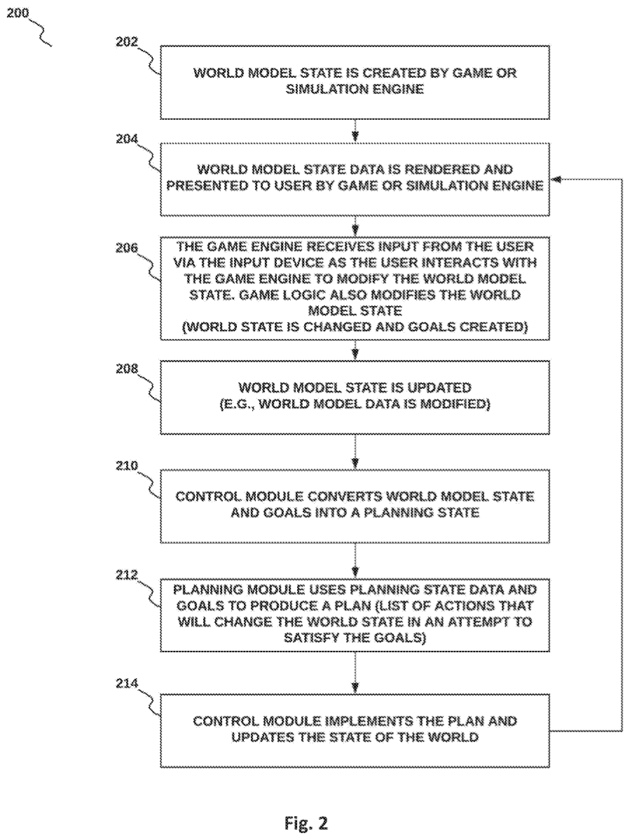

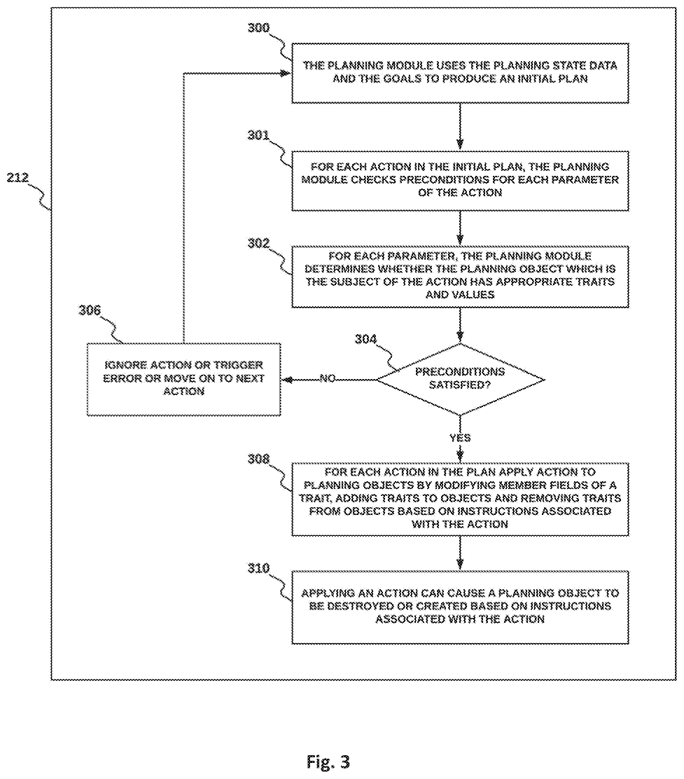

Turning now to the drawings, systems and methods, including non-routine or unconventional components or operations, or combinations of such components or operations, for behavior generation using a trait-based planning domain language, in accordance with embodiments of the invention are illustrated. In accordance with an embodiment, FIG. 1 is an illustration of a behavior generation system 100. The behavior generation system 100 includes a behavior generation device 102. The behavior generation device 102 includes a processing device including one or more central processing units 104 (CPUs), one or more graphics processing units (GPUs) 105, a memory 106, an input device 108, and a display device 110. The input device 108 is any type of input unit such as a mouse, a keyboard, a touch screen, a joystick, a microphone, a camera, and the like, for inputting information in the form of a data signal readable by the processing device 104. The processing device 104 is any type of processor, processor assembly comprising multiple processing elements (not shown), having access to the memory 106 to retrieve instructions stored thereon, and execute such instructions. Upon execution of such instructions, the instructions implement the processing device 104 to perform a series of tasks as described herein (e.g., in particular with respect to FIG. 2 and FIG. 3). The memory 106 can be any type of memory device, such as random access memory, read only or rewritable memory, internal processor caches, and the like.

The display device 110 can include a computer monitor, a touchscreen, and a head mounted display, which may be configured to display digital content including video, a video game environment, and integrated development environment and a virtual simulation environment to a developer (or ‘user’) 130. The display device 110 is driven or controlled by the one or more GPUs 105 and optionally the CPU 104. The GPU 105 processes aspects of graphical output that assists in speeding up rendering of output through the display device 110.

In accordance with an embodiment, the memory 106 can be configured to store an application 112 (e.g., a video game, a simulation, a virtual reality experience, an augmented reality experience) that communicates with the display device 110 and also with other hardware such as the input device(s) 108 to present the application on the display device 110 (e.g., to the developer 130). The application could include a game (or simulation) engine 113 that may include one or more modules that provide the following: animation physics for game objects, collision detection for game objects, rendering, networking, sound, animation, and the like in order to provide a game or simulation environment for display on the display device 110. In accordance with an embodiment, the application 112 includes a behavior generation module 114 that provides various behavior generation functionality as described herein. In accordance with an embodiment, the behavior generation module 114 includes a control module 116 and a planning module 118 as described herein. Each of the application 112, the behavior generation module 114, the control module 116 and the planning module 118 includes computer-executable instructions residing in the memory 106 that are executed by the CPU 104 and optionally with the GPU 105 during operation. The application 112 includes computer-executable instructions residing in the memory 106 that are executed by the CPU 104 and optionally with the GPU 105 during operation in order to create a runtime application program such as a video game or simulator. The behavior generation module 114, the control module 116, the planning module 118, and the game engine 113 may be integrated directly within the application 112, or may be implemented as an external pieces of software (e.g., plugins).

In accordance with an embodiment, the behavior generation module 114 includes a planning domain description language (PDDL) or simply a planning domain language (PDL) which includes data that defines a planning domain for the application 112. The planning domain is a definition of a problem to be solved (e.g., by an AI agent) within the application 112 and the PDL is the language in which the problem is described. As an example, when the problem involves generating agent behaviors, the planning domain includes a world model for the agent (e.g., facts about the world that are important for the agent), and a set of actions the agent can execute to modify a state of the world model. As another example, when the problem involves generating a story for storytelling, the planning domain includes important facts that can become true during a story, and the planning domain can also include events that can be triggered to advance the story (e.g., events can change a truth value of some facts).

In accordance with an embodiment, the behavior control module 116 monitors the evolution of a world (e.g., a game world, a simulation world and the real world) and converts a state of the world into a format described by the PDL and referred to herein as a planning state. The conversion may be part of operation 210 as described below with respect to the method 200 described in FIG. 2. As part of the conversion, the behavior control module 116 converts world events (e.g., game events) into planning domain events. A planning domain event is a world event as described with the PDL and which represents a change in the planning state. A planning domain event can include the deletion or creation of a planning domain object, the deletion or addition of a trait to a planning domain object, and the modification of the properties of a trait attached to a planning domain object. As part of the conversion, the behavior control module 116 converts game objects into planning domain objects. In a situation when behavior is generated for an agent such as an NPC and robot, the behavior control module 116 ensures that the planning state is always in sync with a current version of the state of the world model, and the module 116 is responsible for executing decisions from the planning module 118 for the agent. When behavior is generated for a story (e.g., storytelling), the behavior control module 116 monitors the truth value of important facts defined in the world model, and triggers world events to advance the story as decided by the planning module 118.

In accordance with an embodiment, the behavior control module 116 also keeps track of one or more goals for an AI agent. A goal can be an end result that an AI agent must achieve, and a goal can be a state the world needs to pass through. For example, a goal given to the planning module 118 can be represented as a set of conditions a future state of the world model must satisfy. A goal for an AI agent can be specific (e.g., kill the nearest enemy) or abstract (e.g., stay alive as long as possible). In accordance with an embodiment, when the behavior generation module 114 is used for storytelling, a goal can be an event that the story is required to pass through.

In accordance with an embodiment, the behavior generation module 114 includes a behavior planning module 118. In accordance with an embodiment, the behavior planning module 118 solves problems by determining a plan that includes a sequence of actions (e.g., for an AI agent) that will achieve a goal. The plan is a list of actions to be carried out by the control module 116 (e.g., the actions applied to world objects) that will change the planning state (e.g., and world model) in an attempt to satisfy the goals.

In accordance with an embodiment and shown in FIG. 2, is a flowchart of a method 200 for behavior generation using the behavior generation module 114 and a planning domain language on a behavior generation device 102. In accordance with an embodiment, the method 200 occurs during a runtime (e.g., execution) of the application 112 (e.g., during game play or simulation). At operation 202 of the method 200, a world model state is created by the game engine 113. The world model state includes data that describes game objects in the game world and describes game events in the game world at a time during runtime. At operation 204, the game engine 113 uses the world model state data to render part or all of the world and then display it via the display device 110. The rendering can include using a game engine 113 to calculate game event data and game object data. At operation 206, the user interacts with and modifies the world using the input device 108. The user could be playing a game (e.g., using a keyboard or joystick) or interacting with a simulation. The interaction of the user with the world changes the state of the world model (e.g., objects are moved and changed) and creates behavior goals for objects within the world. As part of operation 206, game logic (or simulation logic) also causes the game engine 113 to change the world model state (e.g., to change and create goals). The game logic including instructions within the application 112 that causes the game engine 113 to perform operations on the world model data. At operation 208 of the method 200, the state of the world model is updated by the game engine 113 (e.g., the world model data is modified). At operation 210 of the method 200, the control module 116 converts the updated world model state and goals into a planning state. At operation 212 of the method, the planning module 118 uses planning state data (e.g., from operation 210) and goals (e.g., from operation 206) to produce a plan for the control module 116 to execute. As part of operation 212, the behavior planning module 118 receives as inputs a first state of the planning state at a first time (e.g., the current planning state) and a goal for an agent. The inputs are received from the behavior control module 116. The behavior planning module 118 uses the inputs to compute a plan to drive the planning state from the first state to a goal state (e.g., a planning state associated with the received goal). In accordance with some embodiments, the behavior planning module 118 uses the inputs to compute a state-conditioned policy so that the system supports non-deterministic outputs (e.g., if X occurs, do action 1. Otherwise, if Y occurs, do action 2.) At operation 214 of the method 200, the control module 116 implements the plan (e.g., by implementing actions within the plan) and updates the state of the world model (e.g., modifies the data within the model) and loops back to operation 204.

One benefit of a planning domain description language is to allow a single planning module 118 and a single control module 116 to be used on multiple problems; given that each problem of the multiple problems can be represented in the planning domain language. The control module 116 and the planning module 118 can work on any problem expressed in the planning domain language.

The planning domain language described herein uses a planning domain object to represent an entity that is part of the game world. For example, within a video game, a planning domain object can represent any entity, including: game objects (e.g., an enemy), a location in the game environment, and even non-physical objects such as a food recipe.

In accordance with an embodiment, the planning domain language described herein includes traits and actions. A trait includes a name (e.g., a string) and a plurality of properties. A trait property represents nested information attached to a trait. A trait is attached to a planning domain object and enables the object to be involved in an action. A trait can be attached and removed from a planning domain object during runtime. For example, a trait referred to as “killable” attached to a game object can be defined to signify that the game object can be the subject of an action (e.g., an ‘attack’ action) which allows the game object to be attacked and eventually killed (e.g., destroyed). In a definition for the attack action, it will be specified that a target of the attack action needs to carry the “killable” trait. A trait can be attached to any planning domain object, for example the killable trait can be attached to an enemy character or an inanimate object. A plurality of traits can be attached to a single planning domain object, and different types of planning domain objects (e.g., groups of planning domain objects with similar properties) are implicitly defined by different combinations of traits. The plurality of different combinations of traits (e.g., which implicitly defines a type of planning domain object) are dynamic (e.g., can be modified during runtime) and do not have to be enumerated beforehand (e.g., before runtime).

In accordance with an embodiment, a trait property includes a name (e.g., string), and data. The data can include an integer, a real number, a pointer to a planning domain object with specific traits, and a vector of pointers to planning domain objects with specific traits. In accordance with an embodiment, a trait has member fields wherein data for the properties of a trait can be stored. The property data can be used to quantify an aspect of the trait. Actions can modify the property data within a member field. For example, within a game or simulation, the “killable” trait can be defined to have a property called “Hit Points” (HP) whereby Hit Points is an integer representing the current health of a game object on which the trait is attached. As a consequence, every killable planning domain object in the game (e.g., all game objects with the ‘killable’ trait attached) will include HPs, and actions that act on a planning domain object with the killable trait can modify a value of HP of the object.

Traits are the basic building blocks of a knowledge representation system for the PDL. The relationship between a first planning domain object that can be acted on and a second planning domain object (e.g., an agent) that can act on the first planning domain object can be defined by one or more traits associated with the first planning domain object and one or more traits associated with the second planning domain object. For example, the relationship between a first planning domain object that can be carried (e.g., held and moved around an environment) and a second planning domain object (e.g., an agent) that can carry the first planning domain object can be represented with two traits: a first trait referred to as “carriable” and a second trait referred to as “carrier”. The first trait, “carriable” can be associated with (e.g., attached to) the first planning domain object that can be carried. In accordance with an embodiment, the carriable trait includes at least a property that includes a pointer to a planning domain object, wherein the planning domain object includes the “carrier” trait and represents an agent that is carrying the object. The carriable trait can include a null pointer if it is not being carried. The planning domain object to be carried might also have a second property representing a value of weight for the object (e.g., a real number representing a weight in kilograms). Continuing with the example, the second trait “carrier” may include three properties: a first property representing a maximum total weight that can be carried by a planning domain object on which the second trait is attached; a second property representing a current load of the planning domain object on which the second trait is attached (e.g., a real number at or below the maximum total weight); and third property representing a vector of pointers to a plurality of planning domain objects that each have the “carrier” trait, the plurality of planning domain objects representing a set of planning domain objects being carried at a time (e.g., the vector could be an empty vector). The first trait and the second trait and associated properties can be used to define a plurality of actions around the idea of carrying objects, such as “Pick-up” and “Drop”.

In accordance with an embodiment, the PDL includes aliases. An alias is a shortcut that represents a plurality of traits and can be used to keep action definitions compact. An alias includes a name (e.g., a string) and a list of one or more traits. An alias can be attached to a planning domain object, and the planning domain object will then include the traits that are included within the alias. For example, if an agent (e.g., a planning domain object that can perform an action) has a plurality of traits that include a first trait ‘actor’ which allows the agent to act on other planning domain objects, and a second trait ‘carrier’ which allows the agent to carry carriable planning domain objects, and a third trait ‘localized’ which allows the agent to travel from a first location to a second location, then a collection of the three traits can be combined within an alias and given a name (e.g., ‘mover’). Any planning domain object that has the alias ‘mover’ will have the three traits.

In accordance with an embodiment, during operation (e.g., at runtime) there is provided a planning state that is associated with each measure of time (e.g., every frame). A planning state includes all planning domain objects (and associated data) that exist during the measure of time associated with the planning state. Within a planning state, object traits are attached to (e.g., associated with) planning domain objects and properties are instantiated (e.g., have a value which can include a null value). A planning state determines a set of actions that can be executed. In accordance with an embodiment, an action adds, removes or modifies one or more traits from a planning domain object at runtime (e.g., during game play). The addition, removal and modification of a trait from a planning domain object (e.g., via an action) provides for the evolution of properties of a planning domain object at runtime in a natural way (e.g., incorporating user input as received in operation 206 of the method 200).

In accordance with an embodiment, there is provided an ‘action’ which provides a means through which the control module 116 can perform at least one act on at least one planning domain object. An action can include one or more parameters, one or more preconditions and one or more effects. An action parameter is a planning domain object with traits. An action parameter of an action can be a target for the action. For example, a “Travel” action which performs the act of moving a first planning domain object can include an action parameter, which is a second planning domain object, that represents a destination of the travel act. As another example, a “Pick-up” action, which performs the act of picking up a planning domain object, can include two action parameters: a first parameter which is a carrier agent (e.g., a planning domain object with a ‘carrier’ trait) and a second parameter which is a planning domain object with a ‘carriable’ trait. In accordance with an embodiment, a planning domain object of an action parameter of an action must be present in a planning state for the action to be performed. For example, for a travel action to occur, a planning domain object representing a particular destination that exists in the world must be chosen for an action parameter of the travel action. As another example, for an agent to pick up a game object in a video game, a specific planning domain object representing the agent and a specific planning domain object representing the game object which are both present in a planning state of the video game must be chosen for action parameters of the pick up action.

In accordance with an embodiment, a precondition for an action includes a set of conditions (e.g., logical propositions) that parameters of the action must satisfy for the action to be executable in a planning state. A precondition can require that a planning domain object of a parameter includes one or more specific traits. For example, the pick-up action can have a precondition that requires a parameter representing a carrier agent to have a carrier trait and that a parameter representing a carriable planning domain object have a carriable trait. A precondition can require that a parameter planning domain object have a specific value. For example, in order for an agent to successfully pick-up a carriable planning domain object using a pick-up action, a precondition for the pick-up action can be that a weight value of the carriable planning domain object parameter not exceed a maximum value.

In accordance with an embodiment, an action effect of an action is a sequence of a plurality of transformations that are applied to a planning state as a consequence of the action being executed. The transformations include: the creation or destruction of planning domain objects; the creation or destruction of traits attached to planning domain objects; and a change of value of properties of traits attached to planning domain objects. In accordance with an embodiment, all planning domain objects involved in a transformation in an action effect for an action are parameters of the action.

In accordance with an embodiment, at runtime (e.g., during game play) an action can create one or more planning domain objects and delete one or more planning domain objects within a planning state. The creation and deletion of a planning domain object removes the need to specify in advance all planning domain objects that can exist in, and modify a planning state.

In accordance with an embodiment, an action has an uncertain, probabilistic effect. An action can have a plurality of outcomes. For example, an action can include a set of possible outcomes specified with a probability attached to each outcome. This strongly extends the applicability of the behavior generation system described herein since many real world and video game (e.g., virtual) situations require reasoning about uncertainty in future events to produce correct behavior.

In accordance with an embodiment, actions represent a dynamic knowledge of the game world, and represent a means by which a planning state can evolve over time. During operation (e.g., at runtime during gameplay), the planning module 118 determines a sequence of actions to bring a planning state from a first state (e.g., the current state) to a second state wherein the second state satisfies a set of goal conditions (e.g., as specified by a user during game play or during simulation such as in operation 206 of the method 200 shown in FIG. 2).

In accordance with an embodiment, FIG. 3 shows a flowchart of the operation 212 from the method 200 wherein the planning module 118 produces a plan. At operation 300, the planning module 118 uses machine learning methods with the planning state data and the goals to produce an initial plan. At operation 301, for each action in the initial plan, the planning module 118 checks preconditions for each parameter of the action. At operation 302, for each parameter of an action, the planning module 118 checks whether the planning domain object of the parameter (which may be the subject of the action) has a set of traits and values which are necessary for the action. The necessary set traits and values may be predefined. At operation 306, based on the preconditions not being satisfied, an error condition is triggered (e.g., wherein the action may be ignored, or the planning module 118 may move on to a next action, or the like). At operation 308, based on the preconditions for an action being satisfied, the action is applied to the one or more planning objects within the one or more parameters of the action. In accordance with an embodiment, applying an action to a planning object includes modifying one or more member fields of a trait of the planning object based on instructions within the action, adding one or more traits to the planning object based on instructions within the action, and removing one or more traits from the planning object based on instructions within the action. In accordance with an embodiment, at operation 310, applying an action includes creating and destroying one or more domain planning objects based on instructions within the action.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

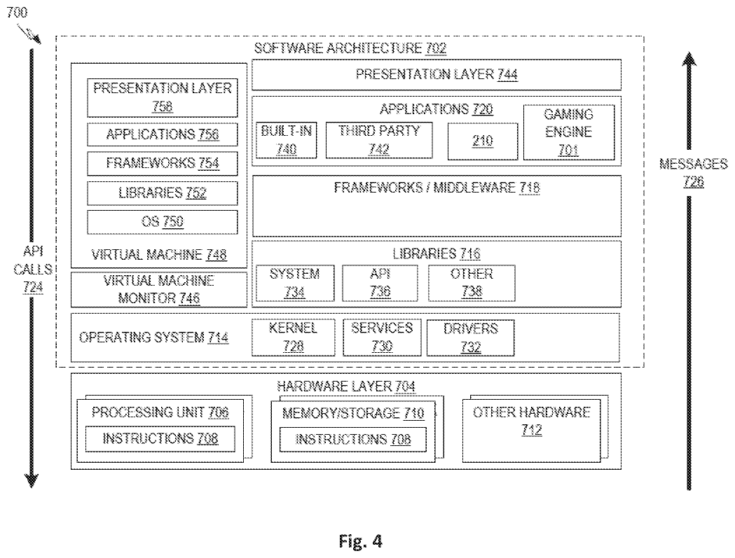

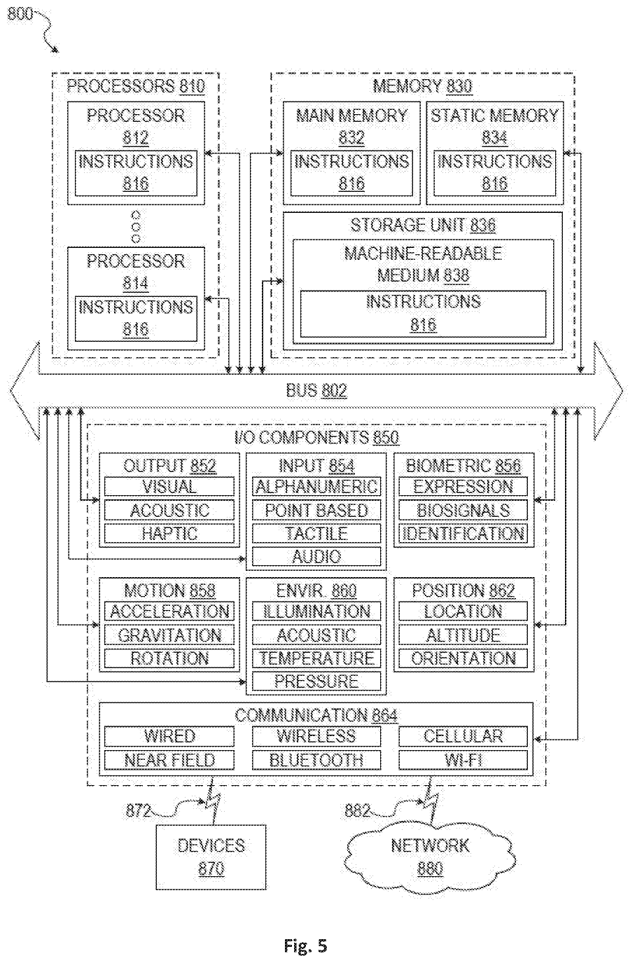

FIG. 4 is a block diagram 700 illustrating an example software architecture 802, which may be used in conjunction with various hardware architectures herein described to provide a gaming engine 701 and/or components of the behavior generation system 200. FIG. 4 is a non-limiting example of a software architecture and it will be appreciated that many other architectures may be implemented to facilitate the functionality described herein. The software architecture 702 may execute on hardware such as a machine 800 of FIG. 5 that includes, among other things, processors 810, memory 830, and input/output (I/O) components 850. A representative hardware layer 704 is illustrated and can represent, for example, the machine 800 of FIG. 5. The representative hardware layer 704 includes a processing unit 706 having associated executable instructions 708. The executable instructions 708 represent the executable instructions of the software architecture 702, including implementation of the methods, modules and so forth described herein. The hardware layer 704 also includes memory/storage 710, which also includes the executable instructions 708. The hardware layer 704 may also comprise other hardware 712.

In the example architecture of FIG. 4, the software architecture 702 may be conceptualized as a stack of layers where each layer provides particular functionality. For example, the software architecture 702 may include layers such as an operating system 714, libraries 716, frameworks or middleware 718, applications 720 and a presentation layer 744. Operationally, the applications 720 and/or other components within the layers may invoke application programming interface (API) calls 724 through the software stack and receive a response as messages 726. The layers illustrated are representative in nature and not all software architectures have all layers. For example, some mobile or special purpose operating systems may not provide the frameworks/middleware 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be used by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 816 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) provide a higher-level common infrastructure that may be used by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 742 may invoke the API calls 724 provided by the mobile operating system such as operating system 714 to facilitate functionality described herein.

The applications 720 may use built-in operating system functions (e.g., kernel 728, services 730 and/or drivers 732), libraries 716, or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures use virtual machines. In the example of FIG. 4, this is illustrated by a virtual machine 748. The virtual machine 748 creates a software environment where applications/modules can execute as if they were executing on a hardware machine (such as the machine 800 of FIG. 5, for example). The virtual machine 748 is hosted by a host operating system (e.g., operating system 714) and typically, although not always, has a virtual machine monitor 746, which manages the operation of the virtual machine 748 as well as the interface with the host operating system (i.e., operating system 714). A software architecture executes within the virtual machine 748 such as an operating system (OS) 750, libraries 752, frameworks 754, applications 756, and/or a presentation layer 758. These layers of software architecture executing within the virtual machine 748 can be the same as corresponding layers previously described or may be different.

FIG. 5 is a block diagram illustrating components of a machine 800, according to some example embodiments, configured to read instructions from a machine-readable medium (e.g., a machine-readable storage medium) and perform any one or more of the methodologies discussed herein. In some embodiments, the machine 110 is similar to the HMD 102. Specifically, FIG. 5 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. As such, the instructions 816 may be used to implement modules or components described herein. The instructions transform the general, non-programmed machine into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines that individually or jointly execute the instructions 816 to perform any one or more of the methodologies discussed herein.

The machine 800 may include processors 810, memory 830, and input/output (I/O) components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that may execute the instructions 816. The term “processor” is intended to include multi-core processor that may comprise two or more independent processors (sometimes referred to as “cores”) that may execute instructions contemporaneously. Although FIG. 5 shows multiple processors, the machine 800 may include a single processor with a single core, a single processor with multiple cores (e.g., a multi-core processor), multiple processors with a single core, multiple processors with multiples cores, or any combination thereof.

The memory/storage 830 may include a memory, such as a main memory 832, a static memory 834, or other memory, and a storage unit 836, both accessible to the processors 810 such as via the bus 802. The storage unit 836 and memory 832, 834 store the instructions 816 embodying any one or more of the methodologies or functions described herein. The instructions 816 may also reside, completely or partially, within the memory 832, 834, within the storage unit 836, within at least one of the processors 810 (e.g., within the processor's cache memory), or any suitable combination thereof, during execution thereof by the machine 800. Accordingly, the memory 832, 834, the storage unit 836, and the memory of processors 810 are examples of machine-readable media 838.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific input/output (I/O) components 850 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 850 may include many other components that are not shown in FIG. 5. The input/output (I/O) components 850 are grouped according to functionality merely for simplifying the following discussion and the grouping is in no way limiting. In various example embodiments, the input/output (I/O) components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 862, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance.

Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

1. A system comprising:
one or more computer processors;
one or more computer memories;
one or more modules incorporated into the one or more computer memories, the one or more modules configuring the one or more computer processors to perform operations for generating behavior with a trait-based planning domain language, the operations comprising:
creating a world model of a dynamic environment, the world model including data defining a state for the world model, the data defining the state including data describing objects within the environment;
receiving input to update the state for the world model, the input including data to change the state and data defining a goal for a future state;
using a machine-learning model to generate a planning state from the state for the world model, the planning state including a plurality of planning domain objects and associated traits, the planning domain objects representing objects within the state for the world model;
using a machine-learning planning module to create a plan, the plan including a plurality of actions to be performed on planning domain objects within the planning state in order to change the state of the world model to a second state wherein the second state is consistent with the goal, and wherein each action of the plurality of actions includes one or more parameters, one or more preconditions, and one or more effects, and wherein each parameter of the one or more parameters includes one or more planning domain objects and associated traits;
performing the plurality of actions within the plan, wherein the performing of the plurality of actions includes performing the following operations for each action of the plurality of actions:
determining, for each parameter of the action, whether a planning domain object associated with the parameter has one or more traits that have been predefined as necessary for the execution of the action;
analyzing one or more preconditions associated with one or more parameters of the action and, based on the preconditions being satisfied, applying the action to a planning domain object associated with the parameter by performing one or more of the following based on instructions associated with the action: modifying values within a trait associated with the planning domain object, adding a trait to the planning domain object, and removing a trait from the planning domain object.

2. The system of claim 1, wherein applying the action causes a planning domain object associated with the parameter to be destroyed based on instructions associated with the action.

3. The system of claim 1, wherein applying the action causes a planning domain object associated with the parameter to be created based on instructions associated with the action.

4. The system of claim 1, wherein each action of the plurality of actions includes a plurality of possible independent effects associated with the applying of the action, and one of the plurality of possible independent effects is chosen at random when the action is applied.

5. The system of claim 4, wherein each of the plurality of possible independent effects has an associated probability weighting.

6. The system of claim 1, wherein the dynamic environment includes a video game environment or a simulation environment.

7. The system of claim 1, wherein the received input includes data from an input device used by a human to interact with the dynamic environment.

8. A method comprising:
performing operations for generating behavior with a trait-based planning domain language, the operations comprising:
creating a world model of a dynamic environment, the world model including data defining a state for the world model, the data defining the state including data describing objects within the environment;
receiving input to update the state for the world model, the input including data to change the state and data defining a goal for a future state;
using a machine-learning model to generate a planning state from the state for the world model, the planning state including a plurality of planning domain objects and associated traits, the planning domain objects representing objects within the state for the world model;
using a machine-learning planning module to create a plan, the plan including a plurality of actions to be performed on planning domain objects within the planning state in order to change the state of the world model to a second state wherein the second state is consistent with the goal, and wherein each action of the plurality of actions includes one or more parameters, one or more preconditions, and one or more effects, and wherein each parameter of the one or more parameters includes one or more planning domain objects and associated traits;
performing the plurality of actions within the plan, wherein the performing of the plurality of actions includes performing the following operations for each action of the plurality of actions:
determining, for each parameter of the action, whether a planning domain object associated with the parameter has one or more traits that have been predefined as necessary for the execution of the action;
analyzing one or more preconditions associated with one or more parameters of the action and, based on the preconditions being satisfied, applying the action to a planning domain object associated with the parameter by performing one or more of the following based on instructions associated with the action: modifying values within a trait associated with the planning domain object, adding a trait to the planning domain object, and removing a trait from the planning domain object.

9. The method of claim 8, wherein applying the action causes a planning domain object associated with the parameter to be destroyed based on instructions associated with the action.

10. The method of claim 8, wherein applying the action causes a planning domain object associated with the parameter to be created based on instructions associated with the action.

11. The method of claim 8, wherein each action of the plurality of actions includes a plurality of possible independent effects associated with the applying of the action, and one of the plurality of possible independent effects is chosen at random when the action is applied.

12. The method of claim 11, wherein each of the plurality of possible independent effects has an associated probability weighting.

13. The method of claim 8, wherein the dynamic environment includes a video game environment or a simulation environment.

14. The method of claim 8, wherein the received input includes data from an input device used by a human to interact with the dynamic environment.

15. A non-transitory computer-readable medium storing a set of instructions that, when executed by one or more computer processors, causes the one or more computer processors to perform operations for generating behavior with a trait-based planning domain language, the operations comprising:
creating a world model of a dynamic environment, the world model including data defining a state for the world model, the data defining the state including data describing objects within the environment;
receiving input to update the state for the world model, the input including data to change the state and data defining a goal for a future state;
using a machine-learning model to generate a planning state from the state for the world model, the planning state including a plurality of planning domain objects and associated traits, the planning domain objects representing objects within the state for the world model;
using a machine-learning planning module to create a plan, the plan including a plurality of actions to be performed on planning domain objects within the planning state in order to change the state of the world model to a second state wherein the second state is consistent with the goal, and wherein each action of the plurality of actions includes one or more parameters, one or more preconditions, and one or more effects, and wherein each parameter of the one or more parameters includes one or more planning domain objects and associated traits;
performing the plurality of actions within the plan, wherein the performing of the plurality of actions includes performing the following operations for each action of the plurality of actions:
determining, for each parameter of the action, whether a planning domain object associated with the parameter has one or more traits that have been predefined as necessary for the execution of the action;
analyzing one or more preconditions associated with one or more parameters of the action and, based on the preconditions being satisfied, applying the action to a planning domain object associated with the parameter by performing one or more of the following based on instructions associated with the action: modifying values within a trait associated with the planning domain object, adding a trait to the planning domain object, and removing a trait from the planning domain object.

16. The non-transitory computer-readable medium of claim 15, wherein applying the action causes a planning domain object associated with the parameter to be destroyed based on instructions associated with the action.

17. The non-transitory computer-readable medium of claim 15, wherein applying the action causes a planning domain object associated with the parameter to be created based on instructions associated with the action.

18. The non-transitory computer-readable medium of claim 15, wherein each action of the plurality of actions includes a plurality of possible independent effects associated with the applying of the action, and one of the plurality of possible independent effects is chosen at random when the action is applied.

19. The non-transitory computer-readable medium of claim 18, wherein each of the plurality of possible independent effects has an associated probability weighting.

20. The non-transitory computer-readable medium of claim 15, wherein the dynamic environment includes a video game environment or a simulation environment.
